(19) United States
(12) Patent Application Publication
(10) Pub. No.: US 2015/0082194 A1
(43) Pub. Date: Mar. 19, 2015

(54) METHODS AND SYSTEMS FOR IMPROVING AUDIENCE INTERACTION AT CONFERENCES OR SEMINARS

(71) Applicant: Securely Yours LLC, Bloomfield Hills, MI (US)

(72) Inventor: Sajay RAI, Bloomfield Hills, MI (US)

(73) Assignee: Securely Yours LLC, Bloomfield Hills, MI (US)

(21) Appl. No.: 14/026,673

(22) Filed: Sep. 13, 2013

(51) Int. Cl. G06F 3/0484; H04L 12/18

(52) U.S. Cl. CPC G06F 3/0484; H04L 12/1822
USPC 715/753

(57) ABSTRACT

The present invention describes a method and system for improving the interactive experience at a conference or seminar. Generally, a wireless device includes a presentation assistant application for facilitating communication between a presenter and an audience. The application receives a communication from either the presenter or an audience member. Moreover, the application transmits a communication from an audience member to the presenter, or a presenter to an audience member.

### BACKGROUND OF THE DISCLOSURE

1. Field of the Disclosure

This invention generally relates to methods and systems for enhancing the interactive experience between presenters and audience members during conferences or seminars. This invention also generally relates to a software application operated on wireless devices for enhancing the interactive experience between presenters and audience members during conferences or seminars.

2. Related Art

Audience participation is a major factor in the overall success of a presentation held at a conference or seminar. According to some studies, audiences generally begin to lose focus after twenty or thirty minutes into a presentation. A presenter who fails to engage the audience in a dialogue over the course of the presentation may ultimately be disappointed with the outcome.

One reason contributing to the lack of audience participation at conferences and seminars is the inability of audience members to freely pose questions at their convenience. Generally, audience members must wait until an operator brings over a roving microphone. Since the lag in time is variable and depends upon the queue of audience members with questions, some audience members may forget key aspects of their question. Separately, some audience members may be too shy to pose their question in front of a large audience. The opportunity for receiving a good question from a shy audience member may inevitably be missed.

Some audience members opt not to wait for the roving microphone to pose their question. That is, they attempt to project their voice. In these instances, the presenter and other audience members often have difficulty hearing and understanding the audience member. The question may be repeated by the audience member one or more times causing frustration for all of involved participants.

Some conferences or seminars may include polling equipment to engage the audience. However, polling equipment is expensive to purchase or lease. Moreover, polling equipment takes significant time to assemble before a presentation and dissemble thereafter.

What is desired in the art is an improved system and method for enhancing presentations by allowing audience members to ask questions in real-time at their convenience.

What is also desired in the art is an improved system and method that allows audience members to inform the presenter of their desire to ask a question at a more appropriate time in the future.

What is further desired in the art is a more efficient system and method for delivering polling questions to audience members to improve the interactive experience at conferences or seminars.

### SUMMARY OF THE INVENTION

In one aspect of the invention, there is disclosed a method for improving the interactive experience between a presenter and audience. The method includes a step of providing a wireless device including a memory for storing a presentation assistant application. Communication tools of the application are displayed on a display of the wireless device. The user interface assists presenters or audience members to send a communication. Next, the communication is received by the audience member or the presenter. Further, the communication is transmitted either from the audience member to the presenter, or from the presenter to the audience member.

In another aspect of the invention, there is disclosed a system for improving the interactive experience between a presenter and an audience at a conference or seminar. The system includes a non-volatile memory on a wireless device having stored instructions for a presentation assistant application. The wireless device includes a display, a microphone, and a processor. The microphone is configured to input a communication. The processor is operatively coupled to the memory. The processor is configured to perform instructions of the presentation assistant application including, for example, displaying communication tools of the application on the display, and receiving the communication from the audience member or the presenter.

In yet another aspect of the invention, there is disclosed a non-transitory, computer readable medium that includes a presentation assistant software application for improving the interactive experience at conferences or seminars.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention and intended only to be illustrative.

FIG. 1 illustrates a wireless device in accordance with an aspect of the invention.

FIG. 2 illustrates a home/main screen and a subsequent screen for the presentation assistant application in accordance with another aspect of the invention.

FIG. 3 illustrates a user interface for an audience member on a display of an electronic device according to yet a further aspect of the invention.

FIG. 4 illustrates a user interface for a presenter on a display of an electronic device according to another aspect of the invention.

FIG. 5 illustrates a user interface for a presenter to send or view a question on a display of an electronic device according to yet another aspect of the invention.

FIG. 6 illustrates a system for enhancing the interactive experience at a conference/seminar in accordance with another aspect of the invention.

FIG. 7 illustrates a method for enhancing the interactive experience of audience members at a conference or seminar in accordance with yet another aspect of the invention.

### DETAILED DESCRIPTION

As an initial matter, reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

Audience participation is an important factor to the overall success of a presentation at a conference or seminar. That is, while a presenter should have a firm grasp of the substantive topic of the presentation, this by itself may be insufficient to ensure the message is successfully received by an audience. Based on recent studies, an engaged audience is more likely to retain information disseminated by a presenter. By maintaining an engaged audience, presenters can obtain favorable reviews from audience members which may improve their popularity and profile. Accordingly, presenters are more likely to be invited to present at future conferences or seminars.

One of the objectives of the invention is to improve audience engagement events including but not limited to conferences, seminars, sporting events, concerts, marriage ceremonies, wedding receptions, birthday parties, and religious gatherings.

Another objective of the invention is to reduce the time lag typically present at conferences or seminars for audience members to deliver a question to a presenter.

Yet another objective of the invention is to increase the options in which an audience member may deliver a question to a presenter during a presentation at a conference or seminar.

A further objective of the invention is to improve the vehicle of delivering polling questions to audience members during a presentation at a seminar or conference.

### System

In one aspect of the application, there is disclosed a system of enhancing the interactive experience between presenters and audience members at conferences or seminars. Specifically, communications between presenters and audience members are managed using a presentation assistant software application operating on a wireless device. Accordingly, the presenter and audience members communicate in real-time with each other over a wireless network. This configuration helps eliminate delays when an audience member wants to ask a question to a presenter during the course of a presentation.

Wireless Devices in this application include but are not limited to mobile phones, tablet computers, gaming systems, MP3 players and the like. Reference to a “wireless device” is intended to encompass any compatible mobile technology computing device that connects to a wireless communication network, such as mobile phones, mobile equipment, mobile stations, user equipment, cellular phones, smartphones, handsets or the like, e.g., Apple iPhone, iPad, Google Android based devices, BlackBerry based devices, other types of PDAs or smartphones, wireless dongles, or other mobile computing devices. The term “wireless device” may be interchangeably used and referred to herein as “wireless handset,” “handset,” “mobile device,” “device,” “mobile phones,” “mobile equipment,” “mobile station,” “user equipment,” “cellular phone,” “smartphones,” or “phone.”

The application may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), 4G-LTE, Wireless Fidelity (Wi-Fi), Bluetooth, and/or the like, and/or a combination of two or more thereof.

In particular, a WPAN interconnects devices within a small area, e.g., such as a conference room. Bluetooth technology is particularly relevant in a WPAN for exchanging data via short-wavelength (low bandwidth) radio transmissions between fixed and/or mobile devices in short range, e.g., 5-30 meters. Bluetooth also allows high levels of security. Bluetooth employs a specific radio technology called the frequency-hopping spread spectrum whereby transmitted data is divided into packets and each packet is transmitted on one of the many Bluetooth channels. It usually hops 1,600 times per second. Bluetooth employs a packet based protocol with a ‘master-slave’ structure. Generally, a master may communicate with plural slaves in a piconet. The devices can switch roles, by agreement, whereby the slave becomes the master.

Bluetooth is more convenient than Wi-Fi for exchanging information in locations where wireless internet access is unavailable. Bluetooth also is considered a very safe network. That is, the likelihood for someone outside the network to enter is low. Further, Bluetooth requires fewer hardware components, e.g., a wireless router and wireless access points, and therefore saves on additional cost and space.

The presentation assistant software application is maintained and updated by a server as readily understood by those skilled in the art. The server may include software and suitable computer hardware for responding to requests across the computer network to ensure the presentation assistant software application is operating smoothly. The server may be local, for example, located in the conference room. Alternatively, the server may be remotely located thereby communicating with clients through a network as detailed above.

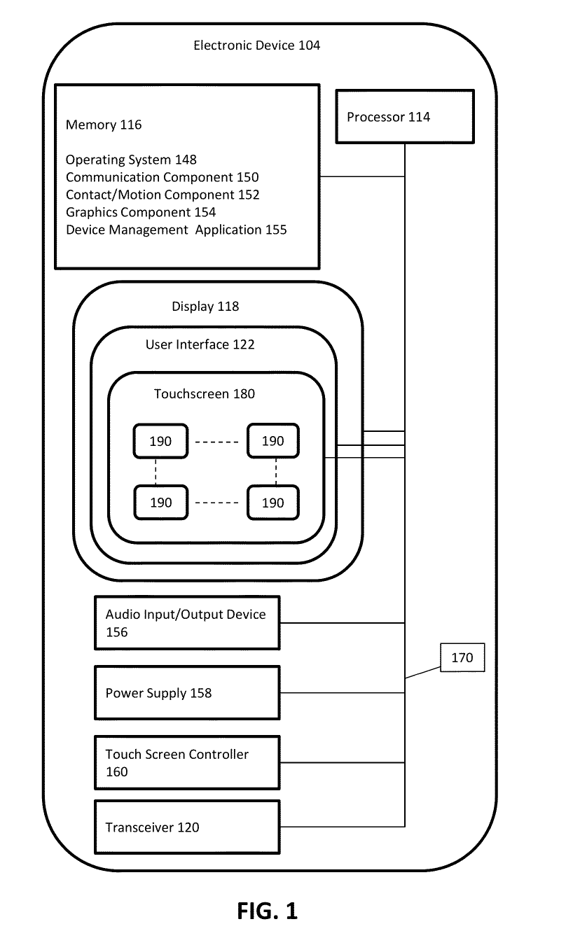

FIG. 1 illustrates an exemplary wireless device, such as a mobile smart phone, which may be employed in aspects of this application. The wireless device 104 includes a processor 114, memory 116, display 118, user interface 122, and the like. The processor 114 may be a central processing unit configured to execute instructions, such as, for example, instructions related to software programs.

The display 118 may be a liquid crystal display having a backlight to illuminate the various color liquid crystals to provide a colorful display. The user interface 122 may be any type of physical input. The input may have buttons and/or may be implemented as a touchscreen 180.

The memory 116 of the wireless device may further include an operating system 148, a communication component 150, a contact/motion component 152, a graphics component 154 and the like. The operating system 148 together with the various components provides software functionality for each of the components of the wireless device.

The memory 116 may include a high-speed, random-access memory. Also, the memory may be a non-volatile or non-transitory memory which stores instructions for the presentation assistant software application. In an exemplary embodiment, the memory element of the system may include but is not limited to a memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. These various components may be connected through various communication lines including a data bus 170.

Additionally, the wireless device may include an audio input/output device 156. The audio input/output device may include speakers, speaker outputs and the like for providing sound output. The audio input/output device may include microphones, microphone inputs and the like for receiving sound inputs. The audio input/output device may include an analog to digital converter and a digital to audio converter for audio input and output functions, respectively.

In an exemplary embodiment, the wireless device may include a transceiver 120. A transceiver is an integrated device which transmits and receives signals in a communications system. Transceivers generally operate in one of two modes—half-duplex or full-duplex. If the transceiver is unable to receive signals while transmitting, it operates in half-duplex mode. If the transceiver is be to receive signals while transmitting, it operates in full-duplex mode. In an exemplary embodiment, a full-duplex mode transceiver is employed. The receiver part of a transceiver includes a front-end portion and a signal-end processing portion. The front-end portion performs the function of baseband signal recovery and is important from a designer's standpoint because its noise figure and linearity determine the overall performance of the transceiver. The signal-processing portion processes the baseband signal according to one of a variety of wireless standards. The processor may be configured to process call functions, data transfer, and the like and provide other services to the user.

In an exemplary aspect, the touchscreen 180 of the invention may be implemented in the display 118 and may detect a presence and location of a touch of a user within the display area. For example, touching the display of the wireless device with a finger or hand. The touchscreen may also sense other passive objects, such as, for example, a stylus.

The display is generally configured to display a graphical user interface (GUI) that provides an easy to use visual interface between a user of the mobile device 104 and the operating system or application(s) running on the mobile device. Generally, the GUI presents programs, files and operational options with graphical images. During operation, the user may select and activate various graphical images displayed on the display in order to initiate functions and tasks associated therewith.

The wireless device also includes a processor 114. The processor is operatively coupled to the memory, e.g., data storage unit. The processor executes the instructions for the presentation assistant software application stored in the memory. In addition, the processor 114 is operatively coupled to the non-volatile memory element. The processor may be a central processing unit configured to execute instructions including instructions related to software programs. The processor may be configured to process call functions, data transfer, and the like and provide other services to the user.

In an exemplary embodiment, the processor may be implemented in any type of mobile smartphone that may be operated by any type of advanced mobile data processing and communication operating system, such as, e.g., an Apple iOS operating system, a Google Android operating system, a RIM Blackberry operating system, a Nokia Symbian operating system, a Microsoft Windows Mobile operating system, a Microsoft Windows Phone operating system, a Linux operating system or the like.

In an exemplary embodiment, the memory element 116 of a mobile device includes a presentation assistant software application 155. Preferably, the mobile device is a hand-held device. More preferably, the hand-held device is a smartphone.

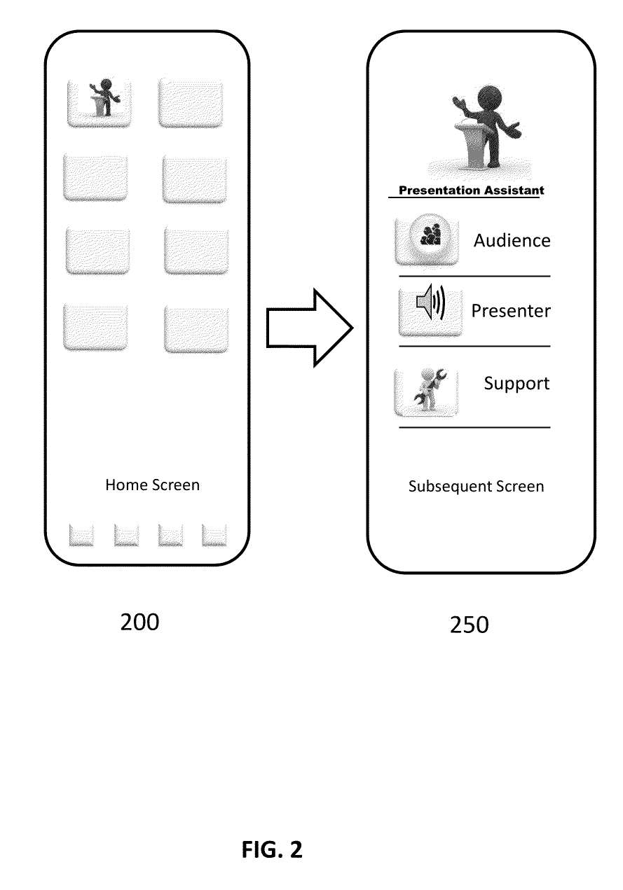

In another exemplary embodiment, the presentation assistant software application may be used by one or more audience members or a presenter at a conference. As shown in FIG. 2, the presentation assistant application may be displayed on a home or main screen 200 of the wireless device. As shown, the electronic device, e.g., a smartphone, includes one or more icons that can be executed. Generally, smartphones may at least include icons related to phone, mail and Internet. In this embodiment, the icon for the presentation assistant application is provided on the home screen. According to the application, the home screen of the electronic device 200 includes all screens and icons viewable by a user upon sliding a finger from left to right, or right to left. Alternatively, the presentation assistant application may be displayed on a subsequent screen 250.

In yet another exemplary embodiment, the subsequent screen 250 displays the features of the presentation assistant application. For example, the application may include one or more icons specifically catered to the audience and presenter. In this embodiment, the audience icon is located above the presenter and support icons. Moreover, the presenter icon is located above the support icons. The illustrations on the icons are exemplary and may be modified in accordance with application preferences. The application may also display a support icon which allows the audience and presenter to configure their user preferences.

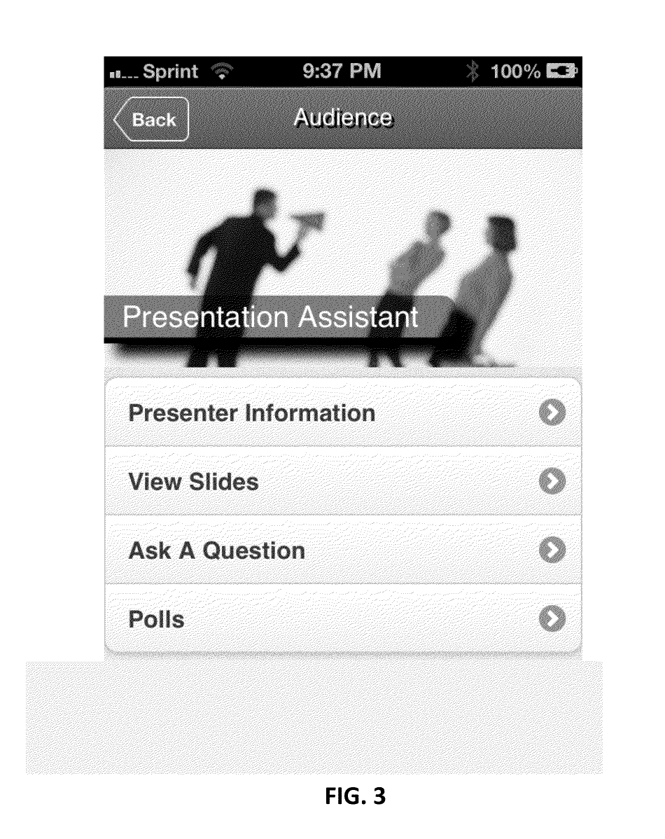

In an exemplary embodiment as shown in FIG. 3, the audience icon displayed on the wireless device may include one or more graphical user interface functionalities including but not limited to ‘Presenter Information’, ‘View Slides’, ‘Ask a Question’ and ‘Polls’. The presenter information provides background information regarding the presenter including, for example, information concerning the presentation, the presenter's educational and professional experiences, the presenter's hobbies/interests, and other relevant information deemed useful by the presenter or staff setting up the conference. The “Ask a Question” function permits an audience member to request a question through the wireless device for review by the speaker. For example, the audience member may select an option on the GUI to submit a “Question Request.” The question request is sent through the presentation assistant application to the presenter. The question request may be queued. In addition, another functionality permits the audience member to speak their question into a microphone of the wireless device. The audience member may also type their question using the keypad. The message is stored by the presentation application and transferred to the presenter through the network. The question may be queued along with questions presented by other audience members. In a preferred embodiment, the network is a PWAN. More preferably, the PWAN is Bluetooth.

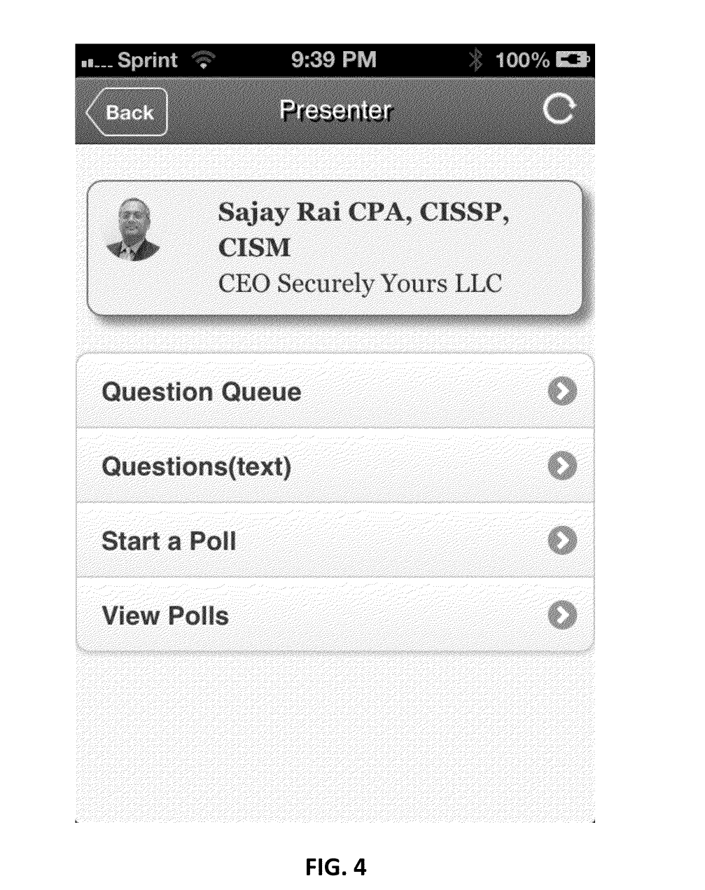

In another exemplary embodiment, the presenter icon includes one or more graphical user interface functionalities including but not limited to ‘Question Queue’, ‘Questions (text)’, ‘Start a Poll’ and ‘View Polls’ as shown in FIG. 4. Under ‘Question Queue’, for example, the presenter is able to view a list of queued questions received by the audience. In addition, the presenter may also view a list of audience members who wish to ask a question in-person. The presenter may initiate contact with any one of the audience members with a question request using the wireless device.

The presenter may submit a ‘Question’ to the audience by typing or speaking (via microphone of the electronic device) showing up as a text message in a text box. The typed or spoken question, upon verification, may be sent by the presenter to one or more members of the audience.

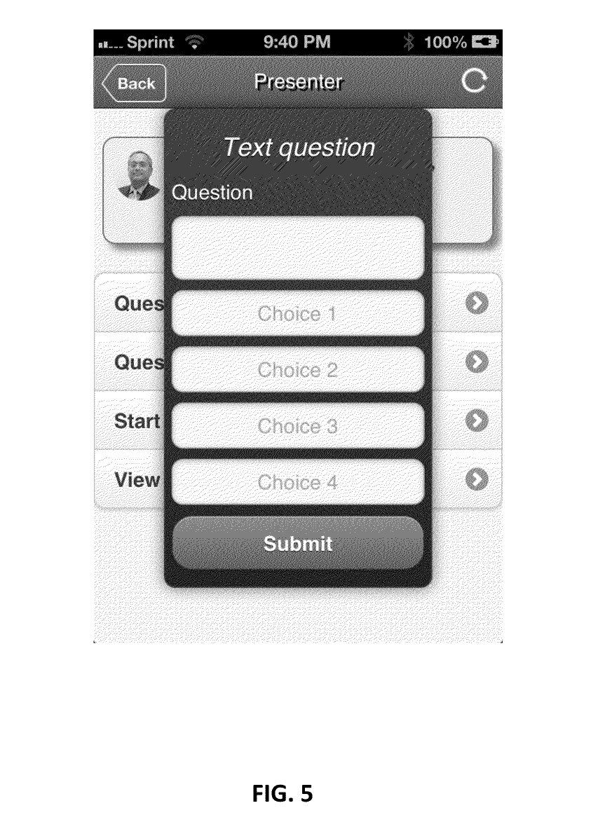

In yet another exemplary embodiment, the presenter may further build polling questions which may be posed to one or more audience members as shown in FIG. 5. Polling generally is a sampling or collection of opinions on a subject for the purpose of analysis, taken from either a selected or a random group of persons. Namely, the presenter may type or speak (with a microphone of the electronic device) a question which populates in a textbox. The presenter may provide one or more choices for the audience, i.e., multiple choice formats, for the question.

The audience may answer the polling questions sent by the presenter. Specifically, the audience may respond by typing or speaking (with a microphone of the electronic device) their response. The polling questions received by the audience members may be queued in multiple ways prior to being sent to the presenter. For example, the questions may be queued by date stamps. Alternatively, the questions may be queued by location of the audience member in the conference room, e.g., first row vs. last row. Alternatively, questions may be quested by topic/subject matter. Further, the presenter is able to review the results of the polling questions and subsequently make the results available to the audience. This can be accomplished either through main screen at the conference and/or on a wireless device of the audience members.

The Support graphical user interface functionality of the presentation assistant application allows the presenter or audience to correct any problems they may be experiencing in advance of, or during the event. For example, the Support feature may include a help feature to connect directly with a technician. The technician may be on-site at the conference, or may be live support directed via telephone. The Support feature may also include a tutorial/library whereby the user can access self-help guides. The Support feature may include user modified settings for typing or posing questions.

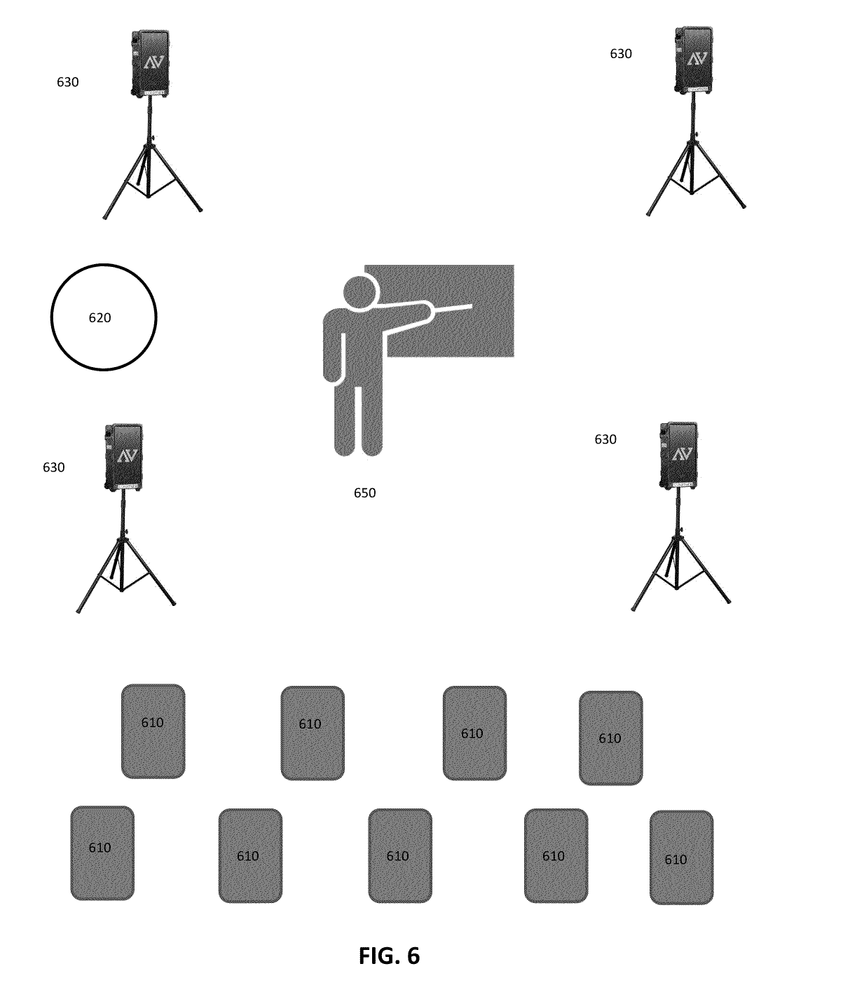

In another aspect of the invention, the system 600 as shown in FIG. 6 may include one or more electronic devices including presentation assistant software for use by audience members. As illustrated, for example, one or more of the audience members may have an electronic device 610 configured with the presentation assistant software application. The application may be loaded in advance of the conference or seminar, or may be provided to the audience just before commencing. In addition, the presenter 650 may also have the application loaded onto a wireless device.

The application may be provided, for example, over a network. The network may be wired or wireless. In an exemplary embodiment, the network is wireless. More preferably, data is exchanged among hardware using one or both of blue-tooth and Wi-Fi technology as understood in the art.

The system may also include one or more receivers or transceivers 320. The receivers or transceivers are configured to receive signal outputs from the transmitters located in the electronic devices. The receivers and transceivers are not limited to any specific models. Preferably these include hardware manufactured or distributed by the following companies: 3Com, Aastra Technologies, Actiance, Adtran, Alacatel-Lucent, AT&T, Avaya, AVST, Aclliotel, Centile, Cisco, COLT Telecom Group, ComputerTalk Technology, Critical Links, Dell, Digium, Ericsson, Esnatech, Global Crossing, Happiest Minds Technologies, IBM, Interactive Intelligence, InterCall, IP Nexia, Jabra, Librestream, LifeSize Communications, MDS Gateways, Microsoft, Mitel, Mondago, Multitech, NEC, Nortel, Oracle Corporation, Outsourcery, PanTerra Networks, Plantronics, Polycom, Presence Networks, Radvision, Revation Systems, ShoreTel, Siemens Enterprise Communications, Solgenia, Speedflow Communications, Tata Communications, THUS, Toshiba, Veriz Tecnologia, Verizon Communications, Vodafone One Net, Webley, Wildix, and Zeacom.

In yet another aspect of the application, embodiment, one or more speakers 630 as shown in FIG. 6 communicate with the receiver/transceiver 620 to transmit sound through the conference. In one embodiment, the speakers 630 may include a transceiver therein. As such, a separate transceiver may not be required. Specifically, the speakers may include any speakers configured to accommodate a conference or seminar space.

In an exemplary embodiment, the presentation assistant software is configured to monitor outputs from electronic devices used by the audience members prior to transmitting to the receiver/transceiver 620. Namely, the application reviews the presenter's previously defined rules/commands as set forth above. The audience members' questions and replies are transmitted through the presentation assistant application to the presenter for review and authorization. By so doing, duplicate or inappropriate questions, for example, may be screened by the presenter to avoid broadcasting the unwanted communication to the entire conference.

In even a further exemplary embodiment, the speaker may adjust the room environment using controls on the presentation assistant application. The presenter may be able to adjust the environment for such things including, but not limited to, lighting controls, window lighting controls, presentation screen controls, sound controls, microphone controls, temperature controls, and air flow controls. Preferably, each of these devices is bluetooth and/or Wi-Fi capable. The speaker can adjust the environment to the conditions he or she thinks are best for viewing the presentation.

In one embodiment, the presenter may be able to retrieve previously used environment settings for use in a current presentation. This may be useful if the presenter is familiar with the environment and the setup is similar to a previous setup. Through the presentation assistant program, the presenter may make further, minor adjustments using controls displayed on the wireless device. The controls may send the appropriate signals to external devices, which have been installed in the conference. These signals may be transmitted by, for example, Infrared Ports, RF Transceiver Ports, or other energy transmission means, wireless or otherwise. Preferably, these external devices include bluetooth or Wi-Fi technology.

In yet a further embodiment, the presentation assistant application includes a language translational conversion tool. The tool converts a language of the audience member into a language understandable by the presenter and the audience at-large. The language tool is useful for audience members who may understand the presented language, e.g., English, yet have difficulty speaking fluently, or in a manner in which others may be able to understand.

In yet even a further embodiment, the presentation assistant application includes a tool for audience members to view presentation slides under the audience tool section. Upon the application receiving the request from the presenter to show the presentation slides, the application makes the slides available for review by audience members in the audience tools section. In one embodiment, an icon may appear indicating the presence of the presentation slides. For example, the icon may be represented as a blank document.

### Method

In yet another aspect of the application, there is described a method for enhancing the interactive experience between presenters and audience members at conferences or seminars. Preferably, the presenter may be capable at any time, e.g., on demand, to transmit speech through a microphone linked with a transmitter on a wireless device directly to a receiver/transceiver/base station in the room connected to speakers. As mentioned earlier, the speakers may serve as a receiver whereby a base station is not required. By so doing, the presenter is able to convey the presentation to the conference or seminar without receiving confirmation from the presentation assistant application to proceed.

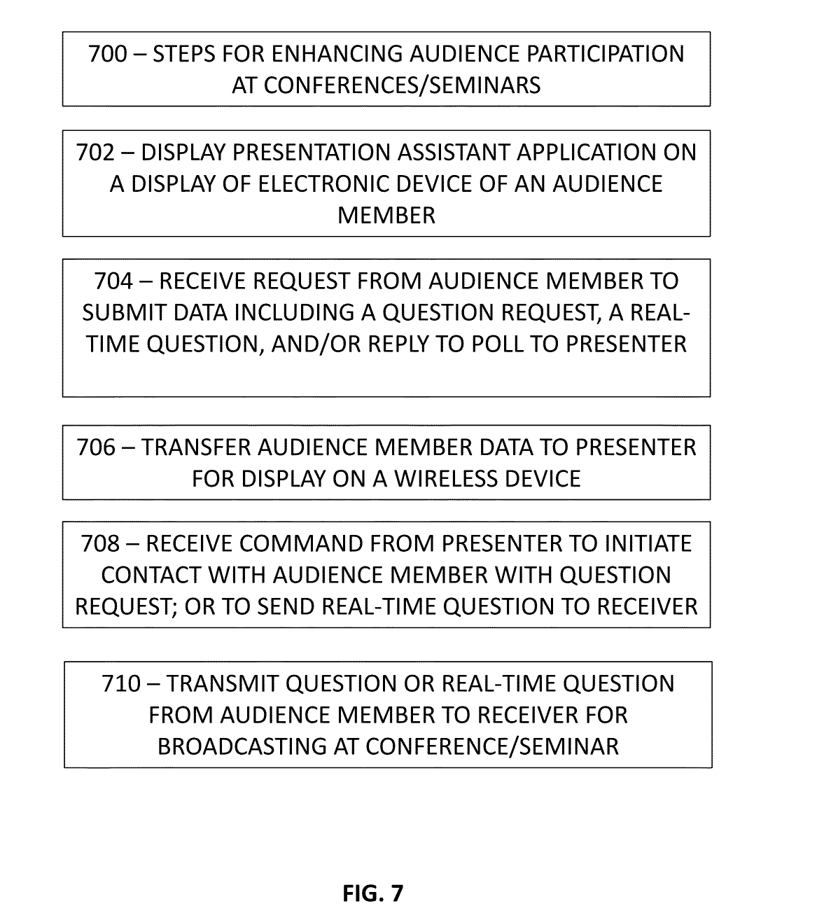

According to an exemplary embodiment as shown in FIG. 7, steps are described for enhancing audience participation at conferences/seminars. For example, presentation assistant application is displayed on the display of the electronic device of an audience member in Step 702. The application may also be displayed on the display of the presenter.

In Step 704, the presentation assistant software application receives a request from an audience member to submit data to the presenter. The data may include a question request, a real-time question and/or a reply to a polling question supplied by the presenter. The request by the audience member preferably may be sent by the tools provided under the audience icon of the application.

The request from the audience member may be sent as an active or passive communication. Active communications are transmitted using a microphone located in or connected to the wireless device. Passive communications are transmitted by typing the question using a keypad, e.g., touchscreen, of the wireless device. Requests received from the presenter may also be active or passive as will be discussed below in more detail.

In Step 706, the presentation assistant application transfers audience data to the presenter and displays the data on the presenter's display of a wireless device. The presenter is able to view the data on the wireless device. The data may be queued in accordance with the presenter's preferences including but not limited to a date stamp, demographics (age, sex, and nationality), location in room, etc. Answers to polling questions from audience members may be stored in the application, in accordance with the presenter's preferences, for purposes of running a statistical analysis.

In another exemplary embodiment, the application is able to queue the request from an audience member desiring to pose a question. Namely, the application holds/stores the question request in accordance with a presenter's previously defined protocol. In one embodiment, the question requests are stored on the application and sent to the presenter upon request. In an alternative embodiment, the question requests automatically are sent to the presenter and are capable of being viewed on the presenter's display.

In STEP 708, the presentation assistant application receives a request from the presenter to done one of many things. For example, the request may be to initiate contact with the audience member submitting the question request, i.e., audience member ask a question before the group at a later time. Alternatively, the presentation assistant application receives a command from the presenter to send a real-time question, i.e., a question posed by the audience member either actively or passively through their wireless device, to the receiver.

In an exemplary embodiment, the presentation application receives a request from the presenter to initiate contact with one of the audience members. This may occur when an audience member has sent a question request. That is, the audience member prefers to ask the question “live” to the seminar. The presenter may initiate contact in one of many ways including for example, tapping on an icon representing the audience member. The icon may show the name and location of the audience member. A prompt from the application such as, for example, “Are you sure you want to connect?” may be received by the presenter. Upon confirmation of initiating contact, the presenter may speak directly with the audience member through their respective microphones on the wireless devices. The sound is transmitted to a receiver in the room connected to speakers which broadcasts the communication to the conference or seminar. Preferably, the transmission is via Bluetooth or Wi-Fi. More preferably, the transmission is via Bluetooth.

In another exemplary embodiment, the application is able to queue a question on a presenter's device that was sent by an audience member. Namely, the application may hold/store the audience member's question in accordance with the presenter's previously defined protocol. In one embodiment, the questions are stored on the application and sent upon request by the presenter. In an alternative embodiment, the question sent by the audience member is sent directly to the presenter and is capable of being viewed on the presenter's display.

In yet another exemplary embodiment, the presentation application receives a request from the presenter to view all submitted questions from the audience. This may occur when an audience member sends a question either textually or by speaking. The presenter may view the question by tapping on an icon representing the selected audience member. The presenter may then do one of two things. The presenter may read the question aloud to the audience if textual, or privately listen to the spoken question and recite it aloud to the audience. Alternatively, upon reviewing the question, whether it be textual or spoken, the presenter may command the presentation assistant to send the audience member's question to the receiver to be heard by the entire audience. Preferably, the transmission is via Bluetooth or Wi-Fi. More preferably, the transmission is via Bluetooth.

In STEP 710, the presentation assistant application transmits a question from the audience member that was reviewed by the presenter to the receiver for broadcasting to the conference. In one embodiment, upon the presenter initiating contact with the audience member, the audience member's speech is permitted to be sent to the receiver until the presenter requests the presentation application to cease transmitting the audience member's speech to the receiver. The presenter may accomplish this by touching an icon on the application allowing the audience member's speech to be terminated, e.g., ended. The presenter may also have the ability to resume communication with the audience member by tapping on an icon, e.g., play/pause button provided in the presenter's tools on the application. This permits the presenter to manage and conduct the presentation.

In an alternative embodiment, the presenter may already have set up a preference in the support icon whereby the audience member's speech is terminated after a predefined amount of time. For example, the audience member may be provided 30 seconds, 1 minute, or more to state the question. If the question is longer than the predefined amount of time, the presenter has the ability to provide more time, e.g., via play/pause button, to the audience member. The presenter may alternatively be able to provide a fixed amount of additional time, e.g., extra 30 seconds, via a button on the user interface.

In yet another exemplary embodiment, the presentation application is capable of receiving polling questions from the presenter. Namely, the presenter either types or talks the questions directly into the microphone which appear in a file. The presenter may also upload questions to the application from another file, e.g., word document or email.

The presenter commands the presentation application to display the polling questions on the audience members' displays. This may occur when the application receives permission from the presenter to transmit the questions to audience members. In one embodiment, the polling questions, or set of questions, may be sent to certain audience members or to the entire audience.

The presentation assistant application may receive answers from the audience. The audience members' replies may directly be sent to the presenter. This may be appropriate in smaller groups whereby the presenter can quickly analyze the statistics without much computing. Alternatively, the presentation assistant application may run a statistical analysis of the results, prior to being sent to the presenter for review.

Upon receipt of the analyzed data from the presentation assistant application, the presenter may command the application to send the results to the audience. The results may also be forwarded to a main display screen in the conference if available.

In yet another embodiment, the presentation assistant application receives a request from the presenter to display presentation slides under the audience tool section of the application. Upon receiving the request, the application makes the presentation slides available for review by the audience members through their wireless devices.

In yet even another exemplary embodiment, the presentation assistant application provides a tool for allowing the presenter or audience to access websites of the seminar or conference in view of permissions provided by the presenter. The websites may provide further information on the agenda of the conference, biographies of the presenters, and other information which the conference organizers or presenter deem would be helpful and informative.

In yet a further exemplary embodiment, the method includes a language translational conversion tool. The tool converts a language of the audience member into a language understandable by the presenter and the audience at-large. The language tool is useful for audience members who may understand the language, e.g., English, but have difficult speaking fluently, or in a manner in which others may be able to understand.

In yet even a further exemplary embodiment, there is included a conference registration interface. Specifically, interested participants may register for the conference. By so doing, the participants' information is provided to the host and reduces the time necessary to register in person. Further, the registration interface may allow users to pay for the conference via credit card, debit card or Paypal. Even further, the registration interface allows users to book their travel reservations including for example, hotel accommodations.

In another aspect of the application, there is disclosed a non-transitory, computer-readable or processor-readable medium capable of storing the presentation application. The terms “computer-readable medium” and “processor-readable medium” include a single medium or multiple media, such as a centralized or distributed database, and/or associated caches and servers that store one or more sets of instructions. The terms “computer-readable medium” and “processor-readable medium” also include any medium that is capable of storing a set of instructions for execution by a processor or that cause a computer system to perform any one or more of the methods or operations disclosed herein.

The computer readable medium stores computer data, which data can include computer program code of the presentation assistant software that is executable by a processor of the electronic device, in machine readable form. In one or more aspects, the actions and/or events of a method, algorithm or module may reside as one or any combination or set of codes and/or instructions on a computer readable medium or machine readable medium, which may be incorporated into a computer program product. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device.

It is to be understood that the system modules and method steps described in this application may be employed in various forms of hardware, software, firmware, special purpose processors or a combination thereof. The application preferably is directed to a process and system utilizing a software application comprising executable code that is operably stored on one or more program storage devices including but not limited to a magnetic floppy disk, RAM, ROM, CD ROM and/or Flash memory.

While the system and method have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. A method for improving the interactive experience between a presenter and an audience comprising the steps of:
providing a wireless device including a memory for storing a presentation assistant application;
displaying communication tools of said application on a display of said wireless device for assisting said presenter or a member of said audience to send a communication;
receiving said communication from said audience member or said presenter; and
transmitting said communication from said audience member to said presenter, or said presenter to said audience member.

2. The method according to claim 1, wherein said communication is received and transmitted via Bluetooth, Wi-Fi or combinations thereof.

3. The method according to claim 1, wherein said wireless device is selected from a smartphone, tablet and laptop.

4. The method according to claim 1, wherein said communication is selected from a question request from said audience member, a question from said audience member, a polling question from said presenter, a polling answer from said audience member, presentation slides from said presenter and combinations thereof.

5. The method according to claim 1, further comprising:
queuing said communication from said audience member; and
displaying said queued communication on said display of said presenter.

6. The method according to claim 5, further comprising:
receiving a request from said presenter to select said queued communication; and
initiating contact between said presenter and said audience member associated with said queued communication.

7. The method according to claim 5, further comprising:
receiving a request from said presenter to select said queued communication; and
receiving a request from said presenter to transmit said queued communication to a receiver to broadcast to said audience.

8. The method according to claim 5, wherein said queuing is selected from:
receipt of said communication by said presenter, location of said audience member at said conference, name of said audience member, demographics, and combinations thereof.

9. The method according to claim 1, wherein
said communication is received from said presenter and said audience member, and
said communication is transmitted from said presenter to said audience member, and said audience member to said presenter.

10. The method according to claim 4, further comprising:
receiving polling answers from said audience, and
analyzing said received polling answers.

11. A system for improving the interactive experience between a presenter and an audience at a conference or seminar comprising:
a non-transitory memory located in a wireless device having instructions stored thereon for a presentation assistant application;
a display coupled to said wireless device;
a processor operatively coupled to said memory, configured to execute said instructions of said application including: (i) displaying communication tools of said application on said display for assisting said presenter or a member of said audience to send a communication; and (ii) receiving said communication from said audience member or said presenter; and
a microphone operatively coupled to said wireless device and configured to input said communication.

12. The system according to claim 11, wherein said processor is further configured to transmit said communication from said audience member to said presenter, or said presenter to said audience member.

13. The system according to claim 12, wherein said communication is received and transmitted via Bluetooth, Wi-Fi or combinations thereof.

14. The system according to claim 11, wherein said wireless device is selected from a smartphone, tablet and laptop.

15. The system according to claim 12, further comprising:
a receiver in communication with said electronic device configured to broadcast said communication to said conference or seminar.

16. The system according to claim 11, wherein said communication is selected from a question request from said audience member, a question from said audience member, a polling question from said presenter, a polling answer from said audience member, presentation slides from said presenter and combinations thereof.

17. The system according to claim 12, wherein said processor is further configured to queue said communication from said audience member, and display said queued communication on said display of said presenter.

18. The system according to claim 17, wherein said processor is further configured to receive a request from said presenter to select said queued communication, and initiate contact between said presenter and said audience member associated with said queued communication.

19. The system according to claim 17, wherein said processor is further configured to receive a request from said presenter to select said queued communication, and receive a request from said presenter to transmit said queued communication to a receiver to broadcast said communication to said audience.

20. The system according to claim 11, wherein said application is configured to receive polling answers from said audience, and analyze said received polling answers.
